(19) United States
(12) Patent Application Publication
(10) Pub. No.: US 2025/0256357 A1
(43) Pub. Date: Aug. 14, 2025

(54) SUBSTRATE MANUFACTURING METHOD

(71) Applicant: DISCO CORPORATION, Tokyo (JP)

(72) Inventor: Yuya SETO, Tokyo (JP)

(21) Appl. No.: 19/038,807

(22) Filed: Jan. 28, 2025

(30) Foreign Application Priority Data
Feb. 8, 2024 (JP) 2024-018115

(51) Int. Cl. B23K 26/53; B23K 26/082; B23K 26/40; B23K 101/40; B23K 103/00

(52) U.S. Cl. CPC B23K 26/53; B23K 26/082; B23K 26/40; B23K 2101/40; B23K 2103/56

(57) ABSTRACT

A substrate manufacturing method includes peel-off layer forming of forming a plurality of rows of peel-off layers inside a workpiece, and, after the peel-off layer forming, separating the workpiece with the plurality of rows of peel-off layers being used as separation initiating points, to manufacture substrates. The peel-off layer forming includes first processing of forming a plurality of rows of first peel-off layers each including a modified portion and each being spaced from one another, and second processing of, after the first processing, forming a plurality of rows of second peel-off layers each including a modified portion and a crack extending from the modified portion and each being located between a pair of adjacent first peel-off layers of the plurality of rows of first peel-off layers.

### BACKGROUND OF THE INVENTION

### Field of the Invention

The present invention relates to a substrate manufacturing method of manufacturing, from a workpiece using gallium oxide as the material, a substrate that is thinner than the workpiece.

### Description of the Related Art

In gallium oxide (Ga₂O₃) which exhibits crystal polymorphism, the monoclinic β phase (β-Ga₂O₃) is the most stable phase. β-phase gallium oxide (hereinafter simply referred to as “gallium oxide”) is a wide gap semiconductor whose bandgap is approximately 4.8 eV. Hence, gallium oxide is expected to be used as the material of such semiconductor devices as power devices.

Semiconductor devices are typically formed with use of a disk-shaped substrate. This substrate is, for example, manufactured by slicing a workpiece with a wire saw in such a manner that a portion that is part of a workpiece such a cylindrical block called an ingot and that has a predetermined thickness is separated (see, for example, Japanese Patent Laid-open No. 2016-13929).

### SUMMARY OF THE INVENTION

In forming semiconductor devices, for example, a substrate having a thickness of approximately 150 μm is used. Further, the wire saw to be used has a thickness of, for example, approximately 300 μm. Hence, when substrates are to be manufactured from a workpiece with use of the wire saw, for example, 60% to 70% of the workpiece is discarded as a cutting margin, leading to poor productivity.

In light of the abovementioned circumstance, an object of the present invention is to provide a substrate manufacturing method capable of improving the productivity of substrates at the time of manufacturing, from a workpiece using gallium oxide as the material, a substrate thinner than the workpiece.

In accordance with an aspect of the present invention, there is provided a substrate manufacturing method of manufacturing, from a workpiece using gallium oxide as a material, a substrate thinner than the workpiece, the method including peel-off layer forming of forming a plurality of rows of peel-off layers inside the workpiece, and separating, after the peel-off layer forming, the workpiece with the plurality of rows of peel-off layers being used as separation initiating points, to manufacture the substrate, in which the peel-off layer forming includes first processing of forming a plurality of rows of first peel-off layers each including a modified portion and each being spaced from one another, and second processing of, after the first processing, forming a plurality of rows of second peel-off layers each including the modified portion and a crack extending from the modified portion and each being located between a pair of adjacent first peel-off layers of the plurality of rows of first peel-off layers, in the first processing, alternately repeated are first laser beam applying of moving the workpiece and a focused spot of a laser beam having a wavelength transmittable through the gallium oxide relative to each other along a first direction in a state in which the focused spot is positioned inside the workpiece, and first indexing feeding of moving the workpiece and a position where the focused spot is to be formed relative to each other along a second direction perpendicular to the first direction, and, in the second processing, alternately repeated are second laser beam applying of moving the workpiece and the focused spot relative to each other along the first direction in a state in which the focused spot is positioned between the pair of adjacent first peel-off layers, and second indexing feeding of moving the workpiece and the position where the focused spot is to be formed relative to each other along the second direction.

Further, an output power level of the laser beam in the first laser beam applying may be set to be smaller than an output power level of the laser beam in the second laser beam applying, in the first processing, the plurality of rows of first peel-off layers each including the crack may be formed, and the crack included in each of the plurality of rows of first peel-off layers may be smaller than the crack included in each of the plurality of rows of second peel-off layers. In this case, preferably, the peel-off layer forming further includes, after the second processing, third laser beam applying of applying the laser beam to at least one of the plurality of rows of first peel-off layers such that the crack further extends.

Alternatively, an output power level of the laser beam in the first laser beam applying may be set to be smaller than an output power level of the laser beam in the second laser beam applying, and, in the first processing, the plurality of rows of first peel-off layers each not including the crack may be formed. In this case, preferably, the peel-off layer forming further includes, after the second processing, third laser beam applying of applying the laser beam to at least one of the plurality of rows of first peel-off layers such that the crack extends from the modified portion.

Alternatively, an output power level of the laser beam in the first laser beam applying may be set to be the same as an output power level of the laser beam in the second laser beam applying, and, in the first processing, the plurality of rows of first peel-off layers each including the crack may be formed. In this case, preferably, the peel-off layer forming further includes, after the second processing, third laser beam applying of applying the laser beam to at least one of the plurality of rows of first peel-off layers and/or at least one of the plurality of rows of second peel-off layers such that the crack further extends.

In addition, a depth of the focused spot from a face side of the workpiece in the first laser beam applying is preferably set to be the same as a depth of the focused spot from the face side in the second laser beam applying.

According to the present invention, after a plurality of rows of first peel-off layers and a plurality of rows of second peel-off layers are formed inside a workpiece, the workpiece is separated with these peel-off layers being used as separation initiating points, and substrates are thus manufactured. This makes it possible to improve the productivity of substrates compared to the case in which substrates are manufactured from the workpiece with use of a wire saw.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1A is a perspective view schematically illustrating an example of an ingot using gallium oxide as a material;

FIG. 1B is a side elevational view schematically illustrating the ingot depicted in FIG. 1A;

FIG. 2 is a flowchart schematically illustrating an example of a substrate manufacturing method;

FIG. 3 is a flowchart schematically illustrating an example of a peel-off layer forming step illustrated in FIG. 2;

FIG. 4 is a perspective view schematically illustrating the manner of the peel-off layer forming step;

FIG. 5 is a flowchart schematically illustrating an example of a first processing step illustrated in FIG. 3;

FIG. 6A is a plan view schematically illustrating the manner of the first processing step;

FIG. 6B is a longitudinal sectional view schematically illustrating, in an enlarged manner, part of the ingot obtained after the first processing step; FIG. 7 is a flowchart schematically illustrating an example of a second processing step illustrated in FIG. 3;

FIG. 8A is a plan view schematically illustrating the manner of the second processing step;

FIG. 8B is a longitudinal sectional view schematically illustrating, in an enlarged manner, part of the ingot obtained after the second processing step;

FIG. 9A is a side elevational view schematically illustrating the manner of a separating step illustrated in FIG. 2;

FIG. 9B is a side elevational view schematically illustrating the manner of the separating step illustrated in FIG. 2; and

FIG. 10 is a flowchart schematically illustrating another example of the peel-off layer forming step illustrated in FIG. 2.

### DETAILED DESCRIPTION OF THE PREFERRED EMBODIMENT

An embodiment of the present invention will be described with reference to the attached drawings. Note that the attached drawings are provided for easy understanding of the present invention and do not necessarily reflect, in an accurate manner, the objects and/or methods in which the present invention is embodied.

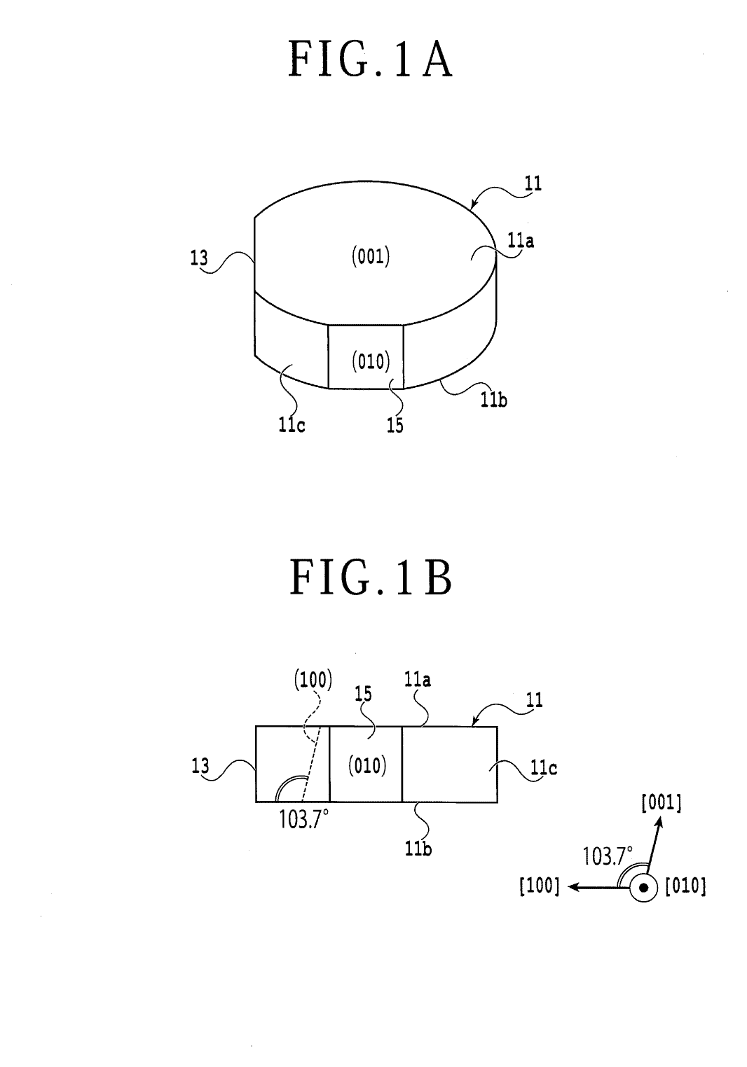

FIG. 1A is a perspective view schematically illustrating an example of an ingot using gallium oxide as the material, while FIG. 1B is a side elevational view schematically illustrating the ingot depicted in FIG. 1A. Note that FIGS. 1A and 1B also depict the crystal plane of gallium oxide included in the ingot. Moreover, FIG. 1B also depicts the crystal orientation of gallium oxide.

Gallium oxide has a monoclinic crystal structure in which the angle formed between the crystal orientation [100] (a-axis) and the crystal orientation [001] (c-axis) is 103.7° and the angles formed between the crystal orientation [010] (b-axis) and the crystal orientation [100] (a-axis) and between the crystal orientation (b-axis) and the crystal orientation [001] (c-axis) are each 90°. The ingot illustrated in FIGS. 1A and 1B and denoted by 11 has a face side 11a and a reverse side 11b that are parallel to each other and on each of which a crystal plane {001} is exposed (here, for the sake of convenience, the plane exposed on the face side 11a is assumed to be the crystal plane (001)).

Note that, while the ingot 11 is so manufactured that the crystal plane {001} is exposed on each of the face side 11a and the reverse side 11b, a plane slightly inclined relative to the crystal plane {001} may be exposed on each of the face side 11a and the reverse side 11b due to processing errors or the like that occurs at the time of manufacture. Specifically, on each of the face side 11a and the reverse side 11b of the ingot 11, a plane which forms an angle of 1° or less with the crystal plane {001} may be exposed.

On a side surface 11c of the ingot 11, two flat portions for indicating the crystal orientation of gallium oxide, that is, a first orientation flat 13 and a second orientation flat 15, are formed. The first orientation flat 13 is longer than the second orientation flat 15 and formed in such a manner as to be positioned at the crystal orientation [100] as viewed from the center of the ingot 11.

The second orientation flat 15 is formed in such a manner as to be positioned at the crystal orientation [010] as viewed from the center of the ingot 11. In other words, the second orientation flat 15 is so formed as to be a plane on which the crystal plane (010) is exposed. Hence, in the ingot 11, the crystal plane (100) forms an obtuse angle of 103.7° with the face side 11a or the reverse side 11b and is perpendicular to the second orientation flat 15.

Note that, on the side surface 11c of the ingot 11, one of or both the first orientation flat 13 and the second orientation flat 15 may not be formed. Further, in the side surface 11c of the ingot 11, a cutout (notch) for indicating the crystal orientation of gallium oxide may be formed in place of the first orientation flat 13 and the second orientation flat 15.

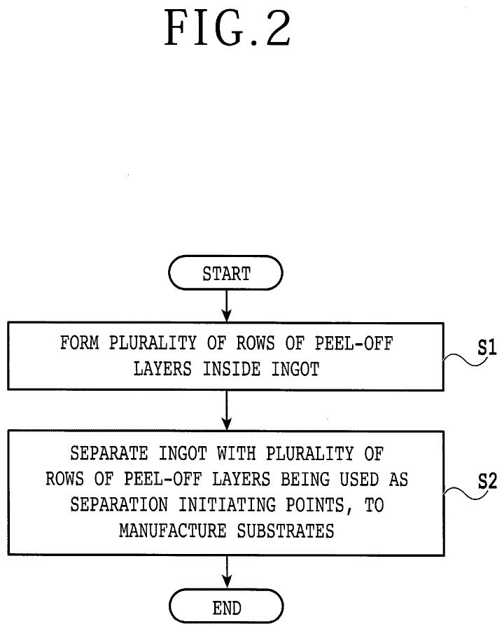

FIG. 2 is a flowchart schematically illustrating an example of a substrate manufacturing method of manufacturing, from the ingot 11 used as a workpiece, a substrate thinner than the ingot 11. In this method, first, a plurality of rows of peel-off layers are formed inside the ingot 11 (peel-off layer forming step S1). Note that each of the peel-off layers includes a modified portion in which the crystal structure of gallium oxide is disordered. Moreover, each of the peel-off layers may include a crack that extends from the modified portion.

In the peel-off layer forming step S1, a plurality of rows of peel-off layers are formed one by one inside the ingot 11. Yet, when the plurality of rows of peel-off layers are formed one by one from one end, that is, when one peel-off layer that is positioned at the end in a direction perpendicular to the direction in which the peel-off layers extend is formed first and the other peel-off layers are formed one by one in such a manner as to be adjacent to the peel-off layer formed immediately prior to the current one, an extremely long crack sometimes extends from the modified portion included in the peel-off layer while the peel-off layers are being formed.

Specifically, when the peel-off layers are formed in the order described above, internal stress generated in the ingot 11 in association with the formation of the modified portions included in the peel-off layers acts on the modified portion included in the newly formed peel-off layer, and a crack excessively extends from the newly formed modified portion, in some cases. In other words, when the internal stress accumulated in association with the formation of the modified portions becomes excessive, an extremely long crack is, in some cases, formed in the newly formed modified portion in order to collectively release the accumulated internal stress.

In this case, there is a possibility that the crack extends to a region of the ingot 11 in which formation of peel-off layers is not intended and makes it difficult to thereafter form desired peel-off layers in the region. Further, in this case, the components of the crack along the thickness direction of the ingot 11 may become greater and reduce the productivity of substrates when the substrates are to be formed from the ingot 11.

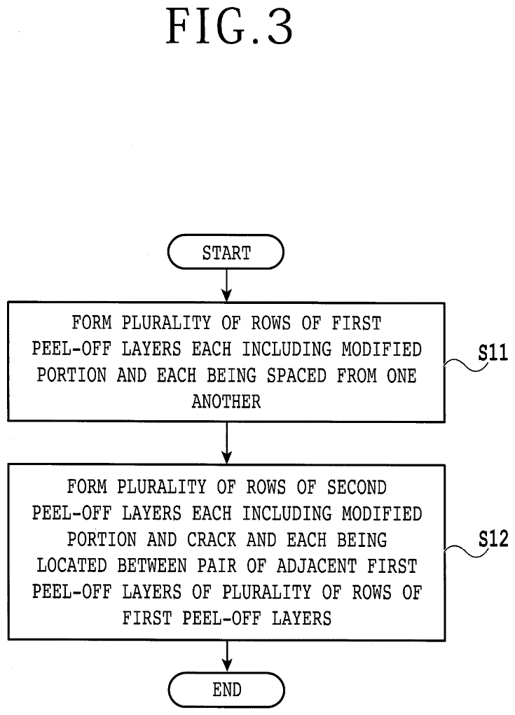

As such, in the peel-off layer forming step S1, a plurality of rows of peel-off layers are formed inside the ingot 11 in such an order that cracks do not excessively extend from the modified portions. FIG. 3 is a flowchart schematically illustrating an example of the peel-off layer forming step S1 in which a plurality of rows of peel-off layers are formed in such a manner.

In the peel-off layer forming step S1, first, a plurality of rows of first peel-off layers each including a modified portion and each being spaced from one another are formed (first processing step S11). After the first processing step S11, a plurality of rows of second peel-off layers each including a modified portion and a crack and each being located between a pair of adjacent first peel-off layers of the plurality of rows of first peel-off layers are formed (second processing step S12).

More specifically, in the peel-off layer forming step S1, after the plurality of rows of first peel-off layers are formed in such a manner that each region between each pair of adjacent first peel-off layers in the ingot 11 is left unprocessed (first processing step S11), the plurality of rows of second peel-off layers are each formed in the respective remaining plurality of rows of unprocessed regions (second processing step S12).

In this case, in the first processing step S11, the internal stress generated in the ingot 11 in association with the formation of the modified portions included in the first peel-off layers is less likely to act on the modified portion included in the newly formed first peel-off layer. Further, in the second processing step S12, the extendable range of the crack extending from the modified portion included in the second peel-off layer can be limited to the range between a pair of adjacent first peel-off layers.

Note that each of the first peel-off layers includes or does not include, for example, a crack smaller than the crack extending from the modified portion included in each of the second peel-off layers. Alternatively, each of the first peel-off layers may include a crack of substantially the same size as the crack extending from the modified portion included in each of the second peel-off layers.

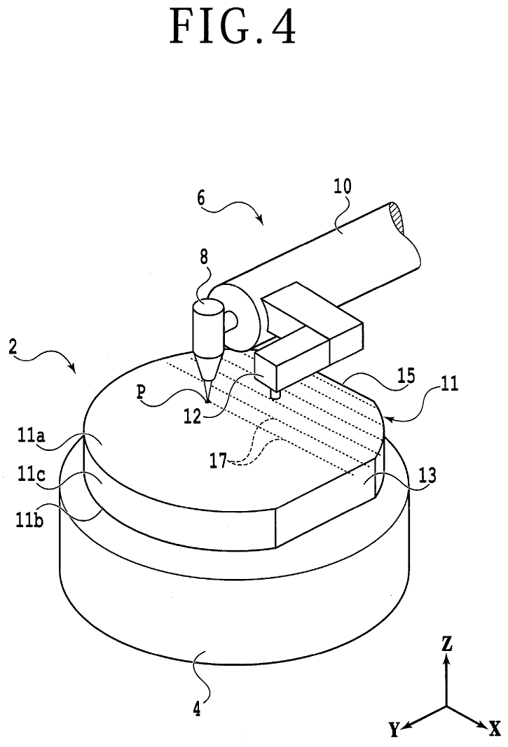

FIG. 4 is a perspective view schematically illustrating the manner of the peel-off layer forming step S1. Note that, in FIG. 4, a direction indicated by an arrow X (X direction) and a direction indicated by an arrow Y (Y direction) are directions perpendicular to each other on a horizontal plane, and a direction indicated by an arrow Z (Z direction) is a direction (vertical direction) perpendicular to the X direction and the Y direction.

The peel-off layer forming step S1 is performed in a laser processing apparatus 2. The laser processing apparatus 2 includes a chuck table 4 that has a circular holding surface substantially parallel to the horizontal plane and that is capable of holding the ingot 11 on this holding surface.

The chuck table 4 is coupled to a suction mechanism (not illustrated). This suction mechanism includes, for example, an ejector or the like. When the suction mechanism is operated, suction force acts in the space near the holding surface of the chuck table 4. Hence, when the suction mechanism is operated in a state in which the ingot 11 is placed on the holding surface, the ingot 11 is held under suction on the holding surface of the chuck table 4.

The chuck table 4 is also coupled to a rotation mechanism (not illustrated). The rotation mechanism includes, for example, a pulley, a motor, and the like. When the rotation mechanism is operated, the chuck table 4 rotates about a straight line passing through the center of the holding surface and extending along the Z direction as the rotational axis. For example, the rotation mechanism rotates the chuck table 4 such that the second orientation flat 15 of the ingot 11 held on the holding surface of the chuck table 4 becomes parallel to the X direction.

A head 8 of a laser beam application unit 6 is provided above the chuck table 4. The head 8 is provided on a distal end portion of a cylindrical housing 10 extending along the Y direction. Note that the head 8 houses an optical system such as a condenser lens (for example, a condenser lens with a numerical aperture (NA) of 0.85) and a mirror, while the housing 10 includes an optical system such as a mirror and/or a lens.

A moving mechanism is coupled to a proximal end portion of the housing 10. The moving mechanism includes, for example, a ball screw, a motor, and the like. When the moving mechanism is operated, the housing 10 moves along the X direction, the Y direction, and/or the Z direction. Further, the laser beam application unit 6 has, for example, a laser oscillator (not illustrated) including neodymium-yttrium-aluminum-garnet (Nd:YAG) or the like as a laser medium.

The laser oscillator generates a laser beam having a wavelength (for example, 1,064 nm) transmittable through gallium oxide (for example, a pulsed laser beam having a frequency of 30 kHZ and a pulse width of 4 ns). The laser beam, after being adjusted in an attenuator such that the output power level thereof has a predetermined value (for example, 0.1 to 2.0 W), is emitted directly downward from the head 8 via the optical systems housed in the housing 10 and the head 8.

An imaging unit 12 capable of imaging the region immediately below it is provided on the lateral portion of the housing 10. The imaging unit 12 includes, for example, a light source such as a light emitting diode (LED) that emits light of a wavelength transmittable through gallium oxide (for example, visible light), an objective lens, and an imaging element such as a charge coupled device (CCD) image sensor or a complementary metal oxide semiconductor (CMOS) image sensor.

When the peel-off layer forming step S1 is performed in the laser processing apparatus 2, first, the ingot 11 is placed on the holding surface of the chuck table 4 such that the face side 11a faces upward. Next, the suction mechanism is operated such that the ingot 11 is held under suction on the holding surface of the chuck table 4. Thereafter, the imaging unit 12 is operated such that an image of the face side 11a of the ingot 11 is formed.

Subsequently, with reference to the image, for example, the rotation mechanism rotates the chuck table 4 such that the second orientation flat 15 becomes parallel to the X direction. That is, the rotation mechanism rotates the chuck table 4 such that the crystal orientation [100] of gallium oxide becomes parallel to the X direction and the crystal orientation [010] of gallium oxide becomes parallel to the Y direction.

Then, the moving mechanism moves the housing 10 along the X direction and/or the Y direction such that the region near one end of the ingot 11 in the Y direction (for example, the region near the second orientation flat 15) is positioned in the X direction as viewed from the head 8 in plan view. Subsequently, the moving mechanism moves the housing 10 along the Z direction such that a focused spot P of the laser beam emitted from the head 8 is positioned at a predetermined depth from the face side 11a of the ingot 11 (for example, a depth of 300 μm from the face side 11a).

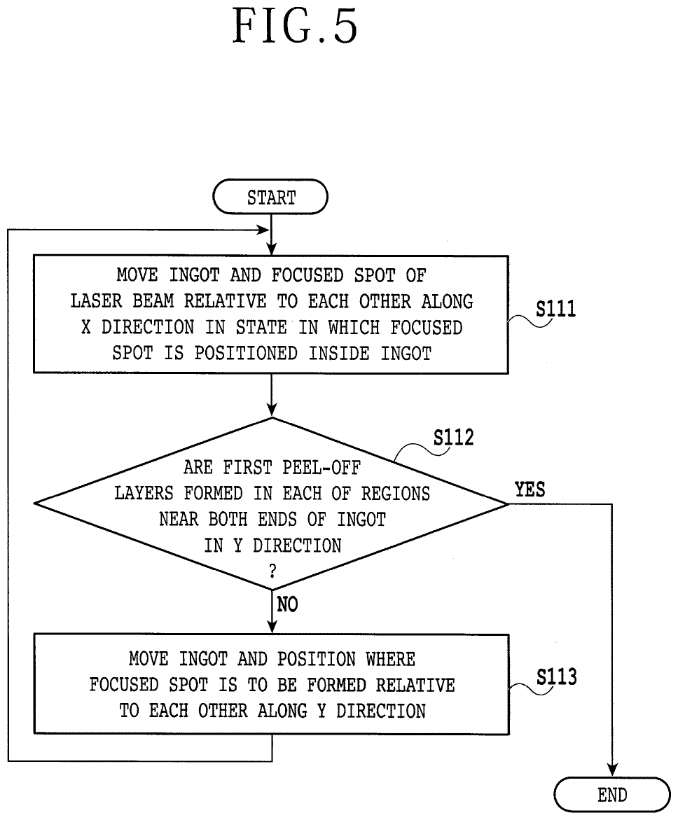

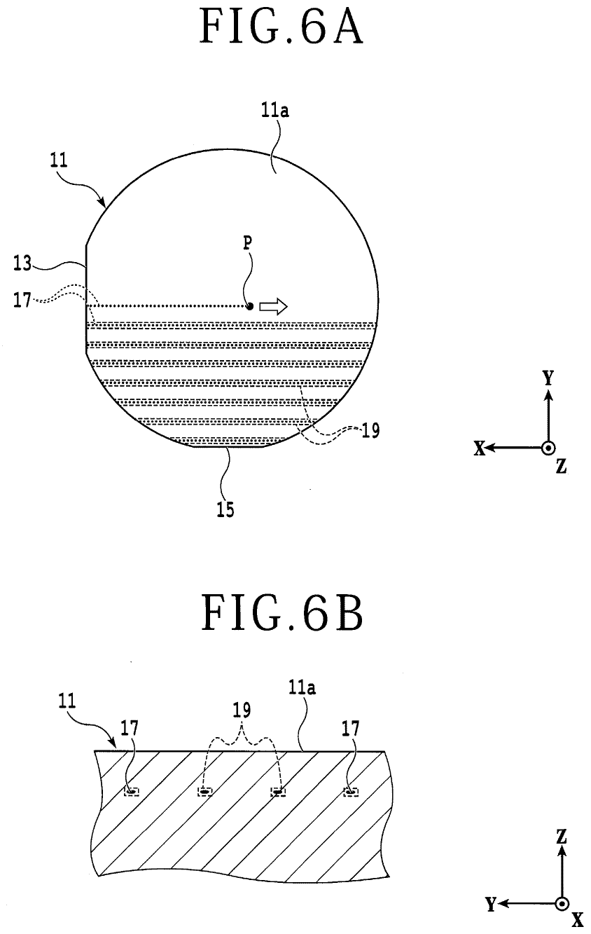

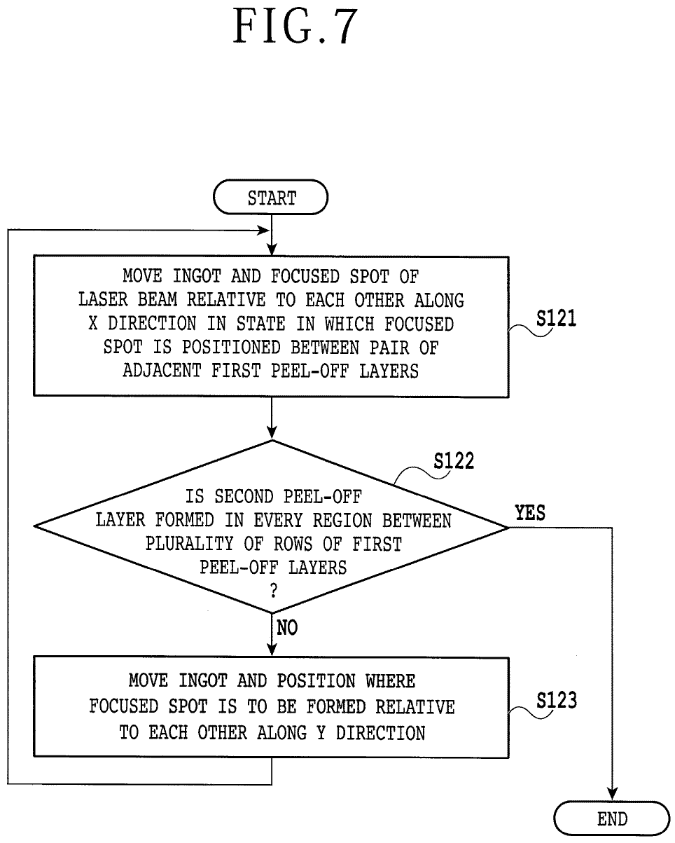

Next, the first processing step S11 is performed. FIG. 5 is a flowchart schematically illustrating an example of the first processing step S11. FIG. 6A is a plan view schematically illustrating the manner of the first processing step S11, while FIG. 6B is a longitudinal section view schematically illustrating, in an enlarged manner, part of the ingot 11 obtained after the first processing step S11.

In the first processing step S11, first, the ingot 11 and the focused spot P of the laser beam are moved relative to each other along the X direction in a state in which the focused spot P is positioned inside the ingot 11 (first laser beam applying step S111).

Specifically, in the first laser beam applying step S111, while a laser beam is being emitted from the head 8, the moving mechanism moves the housing 10 along the X direction such that the focused spot P of the laser beam passes from one end to the other end of the ingot 11 in the X direction at a predetermined speed (for example, 390 mm/s). That is, the laser beam is applied to the ingot 11 with the direction parallel to the crystal orientation [100] of gallium oxide being set as the scanning direction of the laser beam.

This forms, inside the ingot 11, a modified portion 17 in which the crystal structure of gallium oxide is disordered with the focused spot P of the laser beam being the center. When the modified portion 17 is formed inside the ingot 11, the volume of the ingot 11 expands, and internal stress is generated in the ingot 11.

The internal stress becomes greater in proportion to the size of the modified portion 17, i.e., the output power level of the laser beam. When the internal stress becomes greater, cracks extend from the modified portions 17 to release this internal stress. Hence, appropriately setting the output power level of the laser beam makes it possible to control whether or not to allow the cracks to extend from the modified portions 17 and the size of the cracks to a certain extent.

For example, when the modified portion 17 is to be formed but no crack is to be extended from the modified portion 17 in the first processing step S11, the output power level of the laser beam is, for example, set to 0.3 W. Further, when cracks of the same size as the cracks extending from the modified portions 17 formed in the second processing step S12 are to be extended from the modified portions 17 in the first processing step S11, the output power level of the laser beam is, for example, set to 0.8 W. Alternatively, when cracks smaller than the cracks extending from the modified portions 17 formed in the second processing step S12 are to be extended from the modified portions 17 in the first processing step S11, the output power level of the laser beam is, for example, set to 0.4 to 0.7 W.

Note that, in gallium oxide, the crystal plane (100) is most likely to be cleaved, followed by the crystal plane (001). Here, in the first laser beam applying step S111, the scanning direction of the laser beam is set to a direction which forms a large angle with the crystal plane (100) (specifically, the direction parallel to the crystal orientation [100]). In this case, the ingot 11 becomes less likely to be cleaved in the crystal plane (100) of gallium oxide. That is, in the first laser beam applying step S111, generation of cracks having greater components along the thickness direction of the ingot 11 is restrained.

When the focused spot P of the laser beam emitted from the head 8 passes the other end of the ingot 11 in the X direction, the first laser beam applying step S111 is completed. With the first laser beam applying step S111 being performed in the manner described above, linear peel-off layers (first peel-off layers) 19 each including the modified portion 17 and a crack or including the modified portion 17 but not the crack are formed inside the ingot 11. Note that FIGS. 6A and 6B illustrate the first peel-off layers 19 including no cracks for the sake of convenience.

When the first peel-off layers 19 are not formed in each of the regions near both ends of the ingot 11 in the Y direction (step S112: NO), the ingot 11 and the position where the focused spot P is to be formed are moved relative to each other along the Y direction (first index feeding step S113). In the first index feeding step S113, the moving mechanism moves the housing 10 by a predetermined index amount (for example, 0.1 to 0.2 mm) along the Y direction such that the head 8 is positioned in the X direction as viewed from a region slightly farther from the second orientation flat 15 than the region to which the laser beam has most recently been applied, in plan view.

Next, with the opposite direction of the X direction being set as the scanning direction of the laser beam, the first laser beam applying step S111 is performed. Further, the first index feeding step S113 and the first laser beam applying step S111 are alternately repeated until the application of the laser beam is completed for the region near the other end of the ingot 11 in the Y direction (for example, the region farthest from the second orientation flat 15).

In other words, relative movement of the position where the focused spot P of the laser beam is to be formed and the ingot 11 along the Y direction and application of the laser beam to the ingot 11 with the X direction or the opposite direction of the X direction being set as the scanning direction of the laser beam are alternately repeated. When the first peel-off layers 19 are formed in each of the regions near both ends of the ingot 11 in the Y direction (step S112: YES), the first processing step S11 is completed.

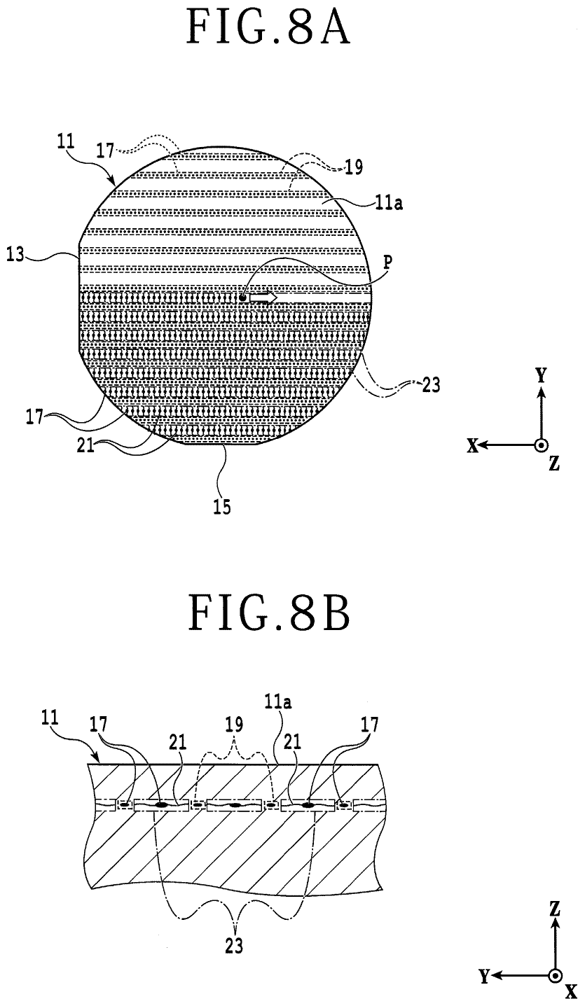

After the first processing step S11, the second processing step S12 is performed. FIG. 7 is a flowchart schematically illustrating an example of the second processing step S12. FIG. 8A is a plan view schematically illustrating the manner of the second processing step S12, while FIG. 8B is a longitudinal sectional view schematically illustrating, in an enlarged manner, part of the ingot 11 obtained after the second processing step S12.

In the second processing step S12, first, the ingot 11 and the focused spot P of the laser beam are moved relative to each other along the X direction in a state in which the focused spot P is positioned between a pair of adjacent first peel-off layers 19 (second laser beam applying step S121).

Specifically, in the second laser beam applying step S121, while a laser beam is being emitted from the head 8, the moving mechanism moves the housing 10 along the X direction such that the focused spot P of the laser beam passes from one end to the other end of the ingot 11 in the X direction at a predetermined speed (for example, 390 mm/s). That is, a laser beam is applied to the ingot 11 with the direction parallel to the crystal orientation [100] of gallium oxide being set as the scanning direction of the laser beam.

Further, in the second laser beam applying step S121, the output power level of the laser beam is set to a value (for example, 0.8 W) that allows a crack 21 to extend from the modified portion 17. As a result, the modified portion 17 and the crack 21 are formed between a pair of adjacent first peel-off layers 19.

When the focused spot P of the laser beam emitted from the head 8 passes the other end of the ingot 11 in the X direction, the second laser beam applying step S121 is completed. Performing the second laser beam applying step S121 in the manner described above forms a linear peel-off layer (second peel-off layer) 23, which includes the modified portion 17 and the crack 21, between the pair of adjacent first peel-off layers 19.

If the second peel-off layer 23 is not formed in any of the regions between the plurality of rows of first peel-off layers 19 (that is, the plurality of rows of unprocessed regions) (step S122: NO), the ingot 11 and the position where the focused spot P is to be formed are moved relative to each other along the Y direction (second index feeding step S123). In the second index feeding step S123, the moving mechanism moves the housing 10 along the Y direction by a predetermined index amount (for example, 0.1 to 0.2 mm) such that the head 8 is positioned in the X direction as viewed from an unprocessed region adjacent to a region that is between a pair of adjacent first peel-off layers 19 and to which the laser beam has most recently been applied.

Next, with the opposite direction of the X direction being set as the scanning direction of the laser beam, the second laser beam applying step S121 is performed. Further, the second index feeding step S123 and the second laser beam applying step S121 are alternately repeated until the application of laser beam is completed for every region between the plurality of rows of first peel-off layers 19.

That is, relative movement of the position where the focused spot P of the laser beam is to be formed and the ingot 11 along the Y direction and application of the laser beam to the ingot 11 with the X direction or the opposite direction of the X direction being set as the scanning direction of the laser beam are alternately repeated. When the second peel-off layer 23 is formed in every region between the plurality of rows of the first peel-off layers 19 (step S122: YES), the second processing step S12 is completed, that is, the peel-off layer forming step S1 is completed.

Note that, in the abovementioned peel-off layer forming step S1 (specifically, the first processing step S11 and the second processing step 12), the direction (the X direction or the opposite direction thereof) parallel to the crystal orientation [100] of gallium oxide is set as the scanning direction of the laser beam, but a direction that is not parallel to the crystal orientation [100] may be set as the scanning direction of the laser beam.

Yet, when the scanning direction of the laser beam becomes parallel to the crystal orientation [010] of gallium oxide, the ratio of cracks 21 that extend along the crystal plane (100) parallel to the crystal orientation [010] may increase. When the ratio of the cracks 21 that extend along the crystal plane (100) increases, the thickness of each of the peel-off layers 19 and 23 (especially, the second peel-off layers 23) formed inside the ingot 11 increases, leading to reduced productivity when substrates are to be manufactured from the ingot 11.

Further, in this case, since the ratio of the cracks 21 that extend along the crystal plane (001), that is, the cracks 21 that extend in parallel with the face side 11a of the ingot 11, decreases, the width (the length in the direction perpendicular to each of the thickness direction of the ingot 11 and the scanning direction of the laser beam) of each the peel-off layers 19 and 23 (especially, each the second peel-off layers 23) formed inside the ingot 11 becomes smaller. Hence, in this case, there is no choice but to reduce the index amount described above, resulting in lower throughput in the laser processing apparatus 2.

In view of these points, in order to improve the productivity and throughput at the time of manufacturing substrates from the ingot 11, the scanning direction of the laser beam is preferably set such that the angle formed between the scanning direction and a straight line parallel to the crystal orientation [010] of gallium oxide becomes large, that is, the angle formed between the scanning direction and a straight line parallel to the crystal orientation [100] becomes small.

Further, in the peel-off layer forming step S1 described above, the depth of the focused spot P of the laser beam from the face side 11a of the ingot 11 is maintained to be constant, but this depth may be changed in mid-course. For example, in the peel-off layer forming step S1, the depth of the focused spot from the face side 11a in the first laser beam applying step S111 and the depth of the focused spot from the face side 11a in the second laser beam applying step S121 may be different.

Yet, the crack 21 that is included in the second peel-off layer 23 formed in the second laser beam applying step S121 more easily extends toward the first peel-off layer 19. Hence, when the two depths are different, the thickness of each second peel-off layer 23 formed inside the ingot 11 increases, and lowers the productivity at the time of manufacturing substrates from the ingot 11. In light of this situation, it is preferable that the two depths be set to be the same in order to improve the productivity at the time of manufacturing substrates from the ingot 11.

Further, in the abovementioned peel-off layer forming step S1, the laser beam may be applied to the ingot 11 only along one direction (for example, the X direction). That is, in the peel-off layer forming step S1, without the opposite direction of the one direction (for example, the opposite direction of the X direction) being set as the scanning direction of the laser beam, application of the laser beam to the ingot 11 with the one direction being set as the scanning direction of the laser beam may be repeated.

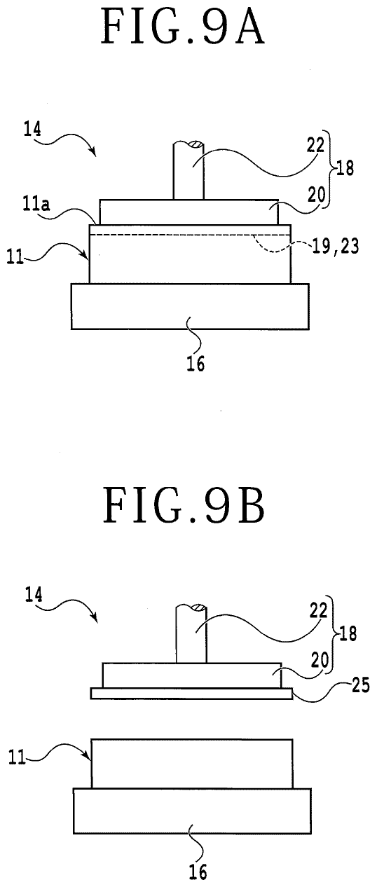

After the peel-off layer forming step S1, with the plurality of rows of peel-off layers 19 and 23 being used as separation initiating points, the ingot 11 is separated, and substrates are manufactured (separating step S2). FIGS. 9A and 9B are each a side elevational view schematically illustrating the manner of the separating step S2. The separating step S2 is performed in a separating apparatus 14. The separating apparatus 14 includes a chuck table 16 having a structure similar to that of the chuck table 4 illustrated in FIG. 4.

The chuck table 16 is coupled to a table-side suction mechanism (not illustrated). The table-side suction mechanism includes, for example, a vacuum pump and the like. When the table-side suction mechanism is operated, suction force acts in a space near a holding surface of the chuck table 16. Hence, when the table-side suction mechanism is operated in a state in which the ingot 11 is placed on the holding surface, the ingot 11 is held under suction on the holding surface of the chuck table 16.

A separating unit 18 is provided above the chuck table 16. The separating unit 18 includes a suction plate 20 which has a lower surface in which a plurality of suction ports are formed. The plurality of suction ports communicate with a separating unit-side suction mechanism such as a vacuum pump via a suction channel formed inside the suction plate 20. When the separating unit-side suction mechanism is operated, suction force acts in a space near the lower surface of the suction plate 20.

Further, a vertical direction moving mechanism 22 is coupled to an upper surface of the suction plate 20. The vertical direction moving mechanism 22 includes, for example, a ball screw, a motor, and the like. When the vertical direction moving mechanism 22 is operated, the suction plate 20 moves along the vertical direction.

When the separating step S2 is performed in the separating apparatus 14, first, the ingot 11 in which the plurality of rows of peel-off layers 19 and 23 are formed is placed on the holding surface of the chuck table 16 such that the face side 11a faces upward, in a state in which the chuck table 16 and the suction plate 20 are sufficiently spaced from each other. Next, the table-side suction mechanism is operated such that the ingot 11 is held under suction on the holding surface of the chuck table 16.

Subsequently, the vertical direction moving mechanism 22 lowers the suction plate 20 such that the lower surface of the suction plate 20 comes into contact with the face side 11a of the ingot 11 (see FIG. 9A). Thereafter, the separating unit-side suction mechanism is operated such that the face side 11a of the ingot 11 is sucked toward the upper side. Then, the vertical direction moving mechanism 22 raises the suction plate 20 such that the suction plate 20 is spaced from the chuck table 16 (see FIG. 9B).

As a result, such external force that separates the face side 11a and the reverse side 11b of the ingot 11 from each other is applied to the ingot 11, and the cracks 21 included in the plurality of rows of peel-off layers 19 and 23 further extend. Consequently, the ingot 11 is separated with the plurality of rows of peel-off layers 19 and 23 being used as separation initiating points, and substrates 25 are manufactured. This completes the separating step S2, that is, the substrate manufacturing method illustrated in FIG. 2.

In the substrate manufacturing method illustrated in FIG. 2, after the plurality of rows of first peel-off layers 19 and the plurality of rows of second peel-off layers 23 are formed inside the ingot 11, the ingot 11 is separated with these peel-off layers 19 and 23 being used as separation initiating points, and the substrates 25 are manufactured. This can improve the productivity of substrates 25 compared to manufacturing the substrates 25 from the ingot 11 with use of a wire saw.

Note that the details described above represent one mode of the present embodiment, the present invention is not limited to the details described above. For example, in the peel-off layer forming step S1 according to the present invention, it is sufficient if the ingot 11 and the focused spot P of the laser beam can be moved relative to each other, and the structure therefor is not limited to any specific kind.

More specifically, the peel-off layer forming step S1 may be performed in a laser processing apparatus provided with a moving mechanism that moves the chuck table 4 along each of the X direction, the Y direction, and/or the Z direction.

Alternatively, the peel-off layer forming step S1 may be performed in a laser processing apparatus in which a scanning optical system capable of changing the direction of the laser beam emitted from the head 8 is provided in the laser beam application unit 6. Note that the scanning optical system includes, for example, a galvanoscanner, an acousto-optic device (AOD), and/or a polygon mirror.

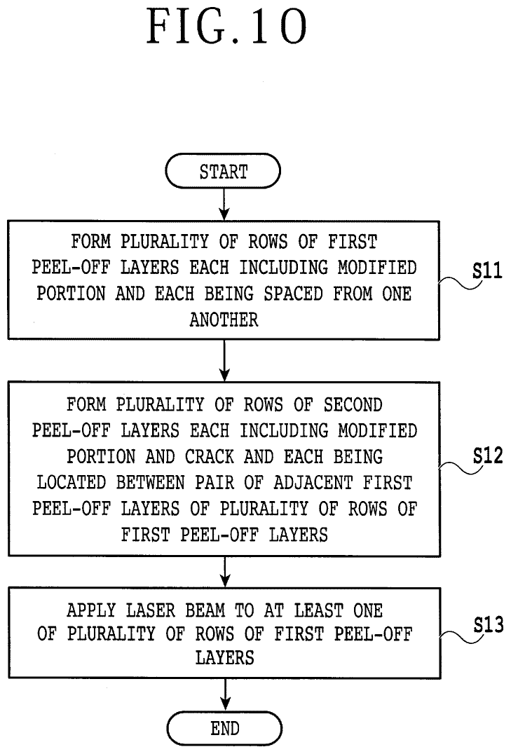

Further, the peel-off layer forming step S1 according to the present invention may include a step that reinforces the plurality of rows of peel-off layers 19 and 23 as separation initiating points, after the second processing step S12. FIG. 10 is a flowchart schematically illustrating an example of the peel-off layer forming step S1 including such a step.

In this peel-off layer forming step S1, a laser beam is applied to at least one of the plurality of rows of first peel-off layers 19 after the second processing step S12 (third laser beam applying step S13).

The third laser beam applying step S13 is, for example, performed in the same manner as the first laser beam applying step S111 described above. Alternatively, the third laser beam applying step S13 may be performed in the same manner as the first processing step S11 described above. That is, in the third laser beam applying step S13, a laser beam may be applied to only one of the plurality of rows of first peel-off layers 19, or a laser beam may be applied to all of the plurality of rows of first peel-off layers 19.

Further, in the third laser beam applying step S13, a laser beam may be applied selectively to the plurality of rows of first peel-off layers 19. For example, in the third laser beam applying step S13, a laser beam may be applied to the even-numbered or odd-numbered first peel-off layer 19 when the plurality of rows of first peel-off layers 19 are counted in an ascending order from the one located on one end to the one located on the other end. Alternatively, in the third laser beam applying step S13, a laser beam may be applied to every k-th first peel-off layer 19 (k is a natural number of three or more) when the first peel-off layers 19 are similarly counted in an ascending order.

When the first processing step S11 is performed such that the first peel-off layers 19 including the cracks 21 are formed, the third laser beam applying step S13 may be performed to further extend the cracks 21 included in the first peel-off layers 19. Alternatively, when the first processing step S11 is performed such that the first peel-off layers 19 including no cracks 21 are formed, the third laser beam applying step S13 may be performed to extend the cracks 21 from the modified portions 17 included in the first peel-off layers 19.

The peel-off layer forming step S1 illustrated in FIG. 10 is preferable in such respects that the ingot 11 can easily be separated in the separating step S2, compared to the peel-off layer forming step S1 illustrated in FIG. 3. In contrast, the peel-off layer forming step S1 illustrated in FIG. 3 is preferable in such respects that the throughput in the laser processing apparatus 2 can be improved, compared to the peel-off layer forming step S1 illustrated in FIG. 10.

Note that, when the first processing step S11 is performed such that the first peel-off layers 19 including cracks 21 of the same size as the cracks 21 included in the second peel-off layers 23 are formed, a laser beam may be applied to at least one of the plurality of rows of second peel-off layers 23 in place of or in addition to at least one of the plurality of rows of first peel-off layers 19.

Further, in the separating step S2 according to the present invention, ultrasonic vibrations may be applied to the ingot 11 as the external force for manufacturing substrates 25. Specifically, in the separating step S2, ultrasonic vibrations may be applied to the face side 11a of the ingot 11, in place of or prior to applying such external force that separates the face side 11a and the reverse side 11b of the ingot 11 from each other.

The workpiece to be used in the substrate manufacturing method according to the present invention may be an ingot manufactured in such a manner that a crystal plane (for example, the crystal plane (100)) other than the crystal plane {001} of gallium oxide is exposed on the face side.

Alternatively, the workpiece to be used in the substrate manufacturing method according to the present invention may, for example, be a bare wafer having a thickness twice or more but five times or less the thickness of the substrate to be manufactured. Note that this bare wafer is, for example, manufactured by separating the ingot in the same manner as that described above. In this case, the substrate 25 can be expressed as being manufactured by the abovementioned method being repeated twice.

As another alternative, the workpiece to be used in the substrate manufacturing method according to the present invention may be a device wafer manufactured by semiconductors devices being formed on one side of the bare wafer. In this case, laser beams are preferably applied to the device wafer from a side of the device wafer where no semiconductor devices are formed, so as to avoid adverse effects on the semiconductor devices.

Other structures, methods, and the like according to the embodiment described above can appropriately be modified within the scope of object of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A substrate manufacturing method of manufacturing, from a workpiece using gallium oxide as a material, a substrate thinner than the workpiece, the method comprising:
peel-off layer forming of forming a plurality of rows of peel-off layers inside the workpiece; and
separating, after the peel-off layer forming, the workpiece with the plurality of rows of peel-off layers being used as separation initiating points, to manufacture the substrate, wherein
the peel-off layer forming includes
first processing of forming a plurality of rows of first peel-off layers each including a modified portion and each being spaced from one another, and
second processing of, after the first processing, forming a plurality of rows of second peel-off layers each including the modified portion and a crack extending from the modified portion and each being located between a pair of adjacent first peel-off layers of the plurality of rows of first peel-off layers,
in the first processing, alternately repeated are first laser beam applying of moving the workpiece and a focused spot of a laser beam having a wavelength transmittable through the gallium oxide relative to each other along a first direction in a state in which the focused spot is positioned inside the workpiece, and
first indexing feeding of moving the workpiece and a position where the focused spot is to be formed relative to each other along a second direction perpendicular to the first direction, and,
in the second processing, alternately repeated are
second laser beam applying of moving the workpiece and the focused spot relative to each other along the first direction in a state in which the focused spot is positioned between the pair of adjacent first peel-off layers, and
second indexing feeding of moving the workpiece and the position where the focused spot is to be formed relative to each other along the second direction.

2. The substrate manufacturing method according to claim 1, wherein
an output power level of the laser beam in the first laser beam applying is set to be smaller than an output power level of the laser beam in the second laser beam applying,
in the first processing, the plurality of rows of first peel-off layers each including the crack are formed, and
the crack included in each of the plurality of rows of first peel-off layers is smaller than the crack included in each of the plurality of rows of second peel-off layers.

3. The substrate manufacturing method according to claim 2, wherein the peel-off layer forming further includes, after the second processing, third laser beam applying of applying the laser beam to at least one of the plurality of rows of first peel-off layers such that the crack further extends.

4. The substrate manufacturing method according to claim 1, wherein
an output power level of the laser beam in the first laser beam applying is set to be smaller than an output power level of the laser beam in the second laser beam applying, and,
in the first processing, the plurality of rows of first peel-off layers each not including the crack are formed.

5. The substrate manufacturing method according to claim 4, wherein the peel-off layer forming further includes, after the second processing, third laser beam applying of applying the laser beam to at least one of the plurality of rows of first peel-off layers such that the crack extends from the modified portion.

6. The substrate manufacturing method according to claim 1, wherein
an output power level of the laser beam in the first laser beam applying is set to be the same as an output power level of the laser beam in the second laser beam applying, and,
in the first processing, the plurality of rows of first peel-off layers each including the crack are formed.

7. The substrate manufacturing method according to claim 6, wherein the peel-off layer forming further includes, after the second processing, third laser beam applying of applying the laser beam to at least one of the plurality of rows of first peel-off layers and/or at least one of the plurality of rows of second peel-off layers such that the crack further extends.

8. The substrate manufacturing method according to claim 1, wherein a depth of the focused spot from a face side of the workpiece in the first laser beam applying is set to be the same as a depth of the focused spot from the face side in the second laser beam applying.

9. The substrate manufacturing method according to claim 2, wherein a depth of the focused spot from a face side of the workpiece in the first laser beam applying is set to be the same as a depth of the focused spot from the face side in the second laser beam applying.

10. The substrate manufacturing method according to claim 3, wherein a depth of the focused spot from a face side of the workpiece in the first laser beam applying is set to be the same as a depth of the focused spot from the face side in the second laser beam applying.

11. The substrate manufacturing method according to claim 4, wherein a depth of the focused spot from a face side of the workpiece in the first laser beam applying is set to be the same as a depth of the focused spot from the face side in the second laser beam applying.

12. The substrate manufacturing method according to claim 5, wherein a depth of the focused spot from a face side of the workpiece in the first laser beam applying is set to be the same as a depth of the focused spot from the face side in the second laser beam applying.

13. The substrate manufacturing method according to claim 6, wherein a depth of the focused spot from a face side of the workpiece in the first laser beam applying is set to be the same as a depth of the focused spot from the face side in the second laser beam applying.

14. The substrate manufacturing method according to claim 7, wherein a depth of the focused spot from a face side of the workpiece in the first laser beam applying is set to be the same as a depth of the focused spot from the face side in the second laser beam applying.
